(19) United States
(12) Patent Application Publication
(10) Pub. No.: US 2011/0098830 A1
(43) Pub. Date: Apr. 28, 2011

(54) Safety Controller

(75) Inventors: Klaus Weddingfeld, Waldkirch (DE); Oliver Koepcke, Neuenburg (DE)

(73) Assignee: SICK AG, Waldkirch (DE)

(21) Appl. No.: 12/879,556

(22) Filed: Sep. 10, 2010

(30) Foreign Application Priority Data
Oct. 23, 2009 (EP) 09173909

(51) Int. Cl. G05B 9/00

(52) U.S. Cl. 700/79

(57) ABSTRACT

A safety controller (10) is set forth having at least one input (18) for the connection of a sensor (20), at least one output (22) for the connection of an actuator (24), at least one communications interface (30) for the connection of a further safety controller (10a-d) to exchange control-relevant information and having a control unit (14) which is made to carry out a control program which generates a control signal with reference to presettable logic rules at the outputs (22) in dependence on input signals at the inputs (18) and/or in dependence on the control-relevant information. In this respect, the control program, when it determines that an expected safety controller (10a-d) is not connected, uses predefined information instead of the safety-relevant information to be transferred from the expected safety controller (10a-d).

The invention relates to a safety controller having a communications interface for the connection of a further safety controller in accordance with the preamble of claim 1 as well as to a method for the generation of control signals in accordance with the preamble of claim 11.

Safety controllers serve inter alia to respond without error in a preset manner on the application of a danger signal. A typical application of safety engineering is the securing of dangerous machinery such as presses or robots which have to be deactivated or secured immediately when an operator approaches in an unauthorized manner. A sensor which recognizes the approach is provided for this purpose, for instance a light grid or a safety camera. If such a sensor recognizes a danger, a safety controller connected to the sensor must absolutely reliably generate a switch-off signal.

In practice, a single sensor does not normally monitor a single machine, but rather a whole series of sources of danger have to be monitored. The corresponding high number of associated sensors, which can each define a switching event, and of suitable measures for the elimination of hazards then only has to be configured and wired in the safety controller. The programming of the safety controller is admittedly supported by professional graphical program interfaces, but above all therefore requires in-depth knowledge because each error in the safety controller results to an endangering of persons. The standard IEC 61131 for the programming of control systems describes in IEC 61131-3 the graphical programming by means of functional modules and in IEC 61131-2 an IO interface description in physical technical values. The configuration of the input and output circuit and its interfaces to sensors and actuators are, however, not standardized.

The machine concepts used in practice are increasingly modular and allow a plurality of options. Modularity means, on the one hand, that the safety controller itself can be expanded in a modular manner to be adapted to changes and additions in the connected sensor system or actuator system. On the other hand, a plurality of safety controllers are also connected to one another in a network. This is sensible, for example, when a respective safety controller is responsible for a machine or for a plant part. In this case, a large part of the control functionality is admittedly in each case locally related to the associated machine. At the same time, there are signals, for example an emergency stop, which the safety controllers have to communicate between one another.

If the structure of the plant is then changed in that machines are added, removed or replaced, the control programs of the safety controllers connected in the network are no longer valid and a reprogramming becomes necessary and a subsequent renewed putting into operation which only correspondingly trained personnel can do. If a safety controller were to be removed from the network without reprogramming, the network would be deemed to be disturbed so that it refuses the release for the operation for technical safety reasons.

In a modular plant with a maximum of n machines which can each be present in a specific application or not, there are 2ⁿ possible part configurations. The same applies to the corresponding network of n safety controllers which are each associated with one of the machines. Conventionally, up to 2n versions of the respective control programming of each safety controller are thus required to image the combinatorics. This is not only a huge effort, but it also requires a qualified and thus error-prone programming or at least a selection of the control programs required in the specific application by a controlling expert. The conventional solutions are thus just as time intensive and cost intensive as inflexible.

It is therefore the object of the invention to provide a simple and secure possibility of adapting a networked safety controller to changes in the plant.

This object is satisfied by a safety controller in accordance with claim 1 and by a method for the generation of control signals in accordance with claim 11. In this respect, the solution starts from the basic idea of designing the control program actually not in dependence on the specific configuration of the networked safety controllers. Instead, the control program always uses the same logic as if safety controllers actually not present were to take part in the network communication. To ensure a meaningful behavior, information is predefined which takes the place of the control-relevant information expected from a safety controller on the lack of this safety controller.

The control program is thus admittedly effective in accordance with the invention in dependence on the recognized configuration of the safety controllers participating in the network. For this purpose, however, the control program does not have to be adapted; the logic rules remain unchanged. The control program only has to decide that the predefined information is used instead of the information to be transferred due to the lack of the expected safety controller in the network.

The invention has the advantage that the same control program covers the total combinatorics of a modular plant. No qualified putting into operation is necessary on changes in the plant design since the control program remains unchanged. The network of safety controllers always remains fully functional independently of the actually specifically present safety controllers. There is thus high flexibility and a very fast possibility to change the plant including the fully functional safety controller.

The control-relevant pieces of information are preferably at least parts of the process image of the respective safety controller. Since the required bandwidth is relatively small in practice, the whole process image is even more preferably transferred. Conditions of some or of all inputs and/or outputs can, for example, be represented as bit values in the process image. Generally, however, the safety controller is free to fix its own process image and, for example, to image intermediate results of the logic. For example, byte 2 bit 4 can mean that a motor 1 is running/is stationary, while byte 3 bit 5 represents emergency stop 3 pressed/not pressed, independently of how complex the sensor system and the logic system is which leads to this result. The width of the transferred process image or generally the number of the transferred information bits of the control-relevant information can also differ between safety controllers connected via the communications interface.

The predefined information is preferably at least part of a notional process image of the expected safety controller in an undisturbed operation. A complete process image is also even more preferably defined here. If the safety controller makes use of this predefined process image in the absence of an expected connected safety controller, the network cluster of safety controllers works just as smoothly as if the missing safety controller were connected.

The communications interface is preferably made for a secure communication. The control-relevant information which is exchanged via the communications interface is generally integrated in the logic rules of the safety controller and thus critical to safety. A possibility for a secure communication is the use of a known bus standard such as CAN or Profibus which is further developed securely by an additional safety protocol or by redundant additional lines.

The safety controller is preferably made in modular design and has at least one connector module with the inputs and/or outputs, with a first connector module being connected to the control unit and the further connector modules being connected to only one prepositioned connector module in each case so that the control unit forms a module series with the connector modules. The modular design of the individual safety controller allows flexible adaptations to the sensor system and actuator system of that machine or of that plant part which is monitored by the safety controller.

The control unit advantageously forms a control module and both the connector modules and the control module are accommodated in a respective housing with outer geometries identical to one another in at least some dimensions, with each connector module having a connection for a prepositioned module and a connection for a postpositioned module of the module series. Module series can thus be set up in a clear manner and with plannable space requirements. The outer geometry of the control module can differ from that of the connector modules in a defined manner to make them better visible and to provide space for the increased requirement of electronics. This difference does not, however, have to relate to all dimensions so that the control module, for example, has the same width and depth, but a different height with respect to the connector modules.

In a further development in accordance with the invention, a plurality of such safety controllers are arranged in a network connected via the communications interfaces, with one of the safety controllers being made as a master and the other safety controllers being made as slaves or with a plurality of or all of the connected safety controllers being made as masters in a multi-master network. A multi.master network in which a plurality of or all of the safety controllers are made as masters supports the modularity since each safety controller can be taken out without disturbing the network communication as long as one master remains in the network. A multi-master embodiment is the most robust in which, as a rule, all complete process images are exchanged between all safety controllers (all-to-all) so that all control-relevant information of the arrangement is available to the safety controller.

The control program of each safety controller in the network preferably uses logic rules for a preset maximum configuration with a preset maximum number of safety controllers. A plant is thus projected in its maximum configuration, the logic rules and control programs are implemented accordingly and the predefined information is saved. Each individual safety controller in operation processes the portion of own control-relevant information and of the control-relevant information exchanged via the network relating to it and communicates the results for their evaluation. If only a part configuration of the maximum configuration is realized in the later specific application, the safety controllers use the stored predefined information for the safety controllers missing with respect to the maximum configuration. The arrangement is thus prepared for all part configurations provided that a part configuration is still sensible and predefined information is stored. It is naturally also conceivable to provide individual safety controllers as obligatory and thus not exchangeable in specific solutions. No predefined information thus has then also to be stored for such safety controllers since these safety controllers will always be present in operation.

The control programs of the individual safety controllers of the arrangement among one another preferably compare, in particular on activation of the safety controller, whether all safety controllers of the arrangement are made for the same maximum configuration. The switching on or booting of the plant is to be understood as activation here. A putting into operation is a special activation in which a new or changed plant is switched on for the first time. A putting into operation usually requires especially qualified personnel and is not absolutely necessary in accordance with the invention if the network configuration of the safety controllers changes. On activation, a check should be made in accordance with this embodiment whether the safety controllers will cooperate sensibly in the specifically realized network. This includes agreement on the used predefined information. This can be interrogated via an identification number, for example.

The control programs of the individual safety controllers of the arrangement among one another preferably compare, in particular on activation of the safety controller, whether the safety controllers of the arrangement correspond to a stored part configuration of the maximum configuration. Even if changes in the arrangement of the safety controllers are supported in accordance with the invention, this may not take place randomly and at any desired times. A replacement during ongoing operation would be evaluated as a failure in a technical safety application and would result in a safety-directed reaction. It must, however, also be recognized on the activation whether the changed network configuration is wanted or, for example, is the result of a defect or of an accidental separation of connection lines. The last set network configuration is therefore saved and a network configuration changed with respect thereto results either directly in the refusal to relapse the plant or a consent of a qualified operator which has to be authorized accordingly is requested.

The method in accordance with the invention can be further developed in a similar manner and shows similar advantages. Such advantageous features are described in an exemplary, but not exclusive, manner in the subordinate claims dependent on the independent claims.

The logic rules and the predefined information are in this respect preferably configured for a maximum configuration of a maximum number of safety controllers in a network. Any desired part configurations can then be selected later in a very simple manner.

An adaptation to a part configuration of the maximum configuration preferably takes place in that safety controllers are removed from or replaced in the network, with the changed configuration in particular being released by an authorization. Due to the predefined information, the reprogramming of the networked safety controllers is already concluded by these simple steps. The control programs do not have to be changed.

A check is advantageously made, in particular on activation of the safety controller, whether all the safety controllers connected to form a network are made for the same maximum configuration. It is thus prevented that safety controllers not coordinated with one another form a network which use, for example, different predefined information.

A check is preferably made, in particular on activation of the safety controller whether all the safety controllers of a stored part configuration connected to form a network correspond to the maximum configuration. Unwanted changes in the network are thus precluded.

The invention will be explained in more detail in the following also with respect to further features and advantages by way of example with reference to embodiments and to the enclosed drawing. The Figures of the drawing show in:

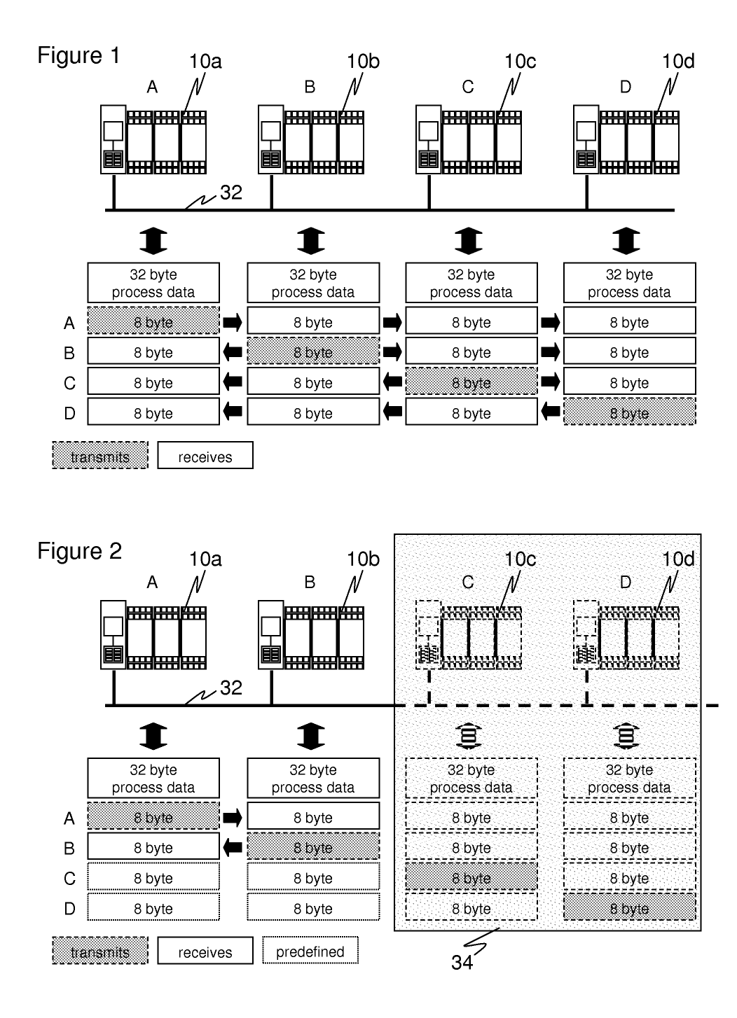

FIG. 1 a schematic block representation of a network of a plurality of safety controllers in a maximum configuration;

FIG. 2 a representation in accordance with FIG. 1 in a part configuration in which some safety controllers have been removed; and

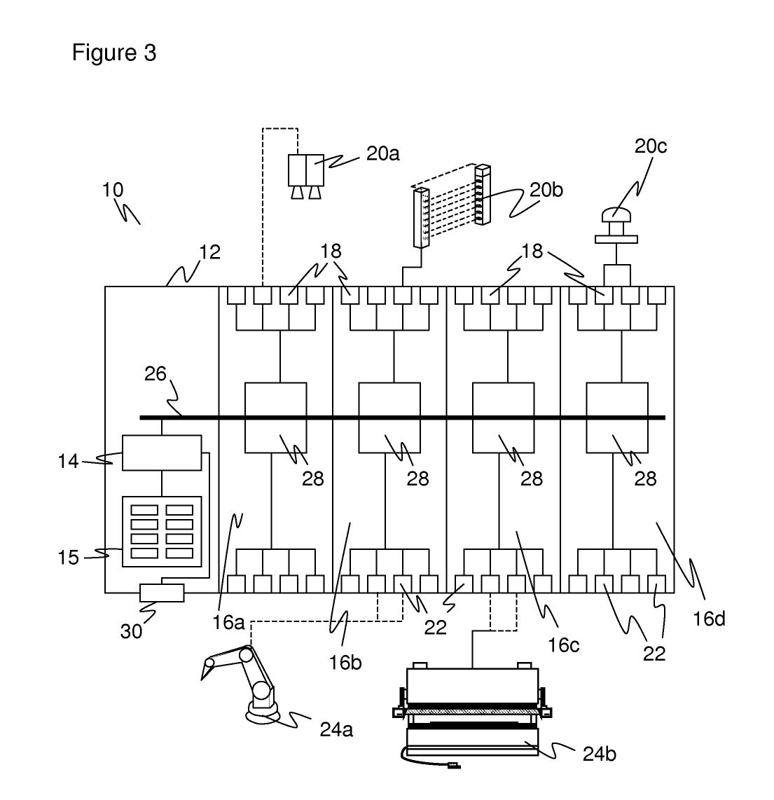

FIG. 3 an overview representation of an exemplary plant with sensors and actuators and their connections to a modular safety controller.

FIG. 3 shows a modular safety controller 10 with a control module 12 which has a safe control unit 14, that is, for example, a microprocessor or another logic module. A memory region 15 is provided in the control module 12 in which one or more predefined process images are stored and which the control unit 14 can access, as explained in more detail further below in connection with FIGS. 1 and 2.

Four connector modules 16a-d are sequentially connected to the control module 12. Inputs 18 for the connection of sensors 20a and outputs 22 for the connection of actuators 24a-b are provided in the connector modules 16a-d. In contrast to the illustration, the connector modules 16a-d can differ in the kind and number of their connectors and only have inputs, only outputs and a mixture of both in different numbers. The arrangement and the physical formation of the connector terminals 18, 22 is adaptable by selection of a specific connector module 16 to different plug types, cable sizes and signal types. Finally, the modules 12, 16-ad are shown in simplified form and can have further elements, for example a respective LED for each connector in a clear arrangement optically emphasizing the association.

The safety controller has the task of providing a safe operation of the sensors 20a-c and above all of the actuators 24a-b, that is to switch off actuators 24a-b in a safety-directed manner (the output 22 is then an OSSD, output switching signal device), to carry out an emergency stop of the plant safely, to consent to any desired control of an actuator 24a-b, particularly to a switching on or a rebooting, to release actuators 24a-b and the like.

A light grid 20b, a safety camera 20a and a switch 20c are examples for safety-relevant sensors or inputs which can deliver a signal on which a safety-directed switching off takes place as a reaction. This can be an interruption of the light beams of the light grid 20b by a body part, the recognition of an unauthorized intrusion into a protected zone by the safety camera 20a or an actuation of the switch 20c. Further safety sensors of any desired kind, such as laser scanners, 3D cameras, safety shutdown mats or capacitive sensors, can be connected to the inputs 18, but also other sensors, for instance for the taking of measurement data or simple switches such as an emergency off switch. All such signal generators are called sensors here and in the following.

In specific applications, sensors 20 are also connected to outputs 22 and actuators 24 to inputs 18, for instance to transfer test signals, to switch a sensor 20 mute temporarily (muting), to blank part regions from the monitored zone of the sensor 20 (blanking) or because an actuator 24 also has its own signal outputs, with which it monitors itself in part, beside an input for controls.

A robot 24a and a press brake 24b are preferably connected to outputs 22 in two-channel manner which represent examples for actuators endangering operators on an unauthorized intrusion. These actuators 24a-b can thus receive a switch-off command from the safety controller 10 to switch them off on recognition of a danger or of an unauthorized intrusion by safety sensors 20a-b or to change them to a safe state. In this respect, the light grid 20a can serve for the monitoring of the press brake 24a and the safety camera 20b can serve for the monitoring of the robot 24b so that mutually functionally associated sensors 20a-b and actuators 24a-b are also each connected to a module 16a and 16b respectively. The functional association, however, takes place via the safety control 14 so that such an imaging of the system is admittedly clearer, but in no way required. Further actuators than those shown are conceivable, and indeed both those which generate a hazardous zone and others, for instance a warning lamp, a siren, a display and the like.

There is a serial communication connection 26 between the control unit 14 and the inputs 18 or the outputs 22 which is known as a backplane, which is in particular a bus and which can be based on a serial standard, on a fieldbus standard such as IO-Link, Profibus, CAN or also on a proprietary standard and can additionally also be designed as failsafe. Alternatively to a bus, a direct connection, a parallel connection or an another connection 26 corresponding to data amounts to be communicated and to the required switching times. The modules 16a-d have a separate controller 28 to be able to participate in the bus communications. For this purpose, a microcompressor, an FPGA, an ASIC, a programmable logic or a similar digital module can be provided. The controllers 28 can also take over evaluation work or carry out distributed evaluations together with the control unit 14 which can range from simple Boolean operations up to complex evaluations, for instance of a three-dimensional safety camera.

The modules 12, 16a-c are each accommodated in uniform housings and are connected to one another mechanically and electrically by connector pieces. The control module 12 thus forms the head of a module series.

The safety controller 14, the inputs 18, the outputs 22 and the bus 26 are made as failsafe, that is by measures such as two-channel design, by divers, redundant, self-testing or otherwise safe arrangements and self-tests. Corresponding safety demands for the safety controller are laid down in the standard EN 954-1 or ISO 13849 (performance level). The thus possible safety classification and the further safety demands on an application are defined in the standard EN 61508 and EN 62061 respectively.

The configuration and programming of the safety controller 10 takes place in practice via a graphical user interface with whose help a control program is prepared and subsequently uploaded.

Provision is made in accordance with the invention to connect a plurality of safety controllers 10 of the described kind together to form a network. For this purpose, the control module 12 has at least one interface 30 via which the safety controllers communicate with one another, for example by means of a secure bus protocol.

FIG. 1 shows a simplified block representation of a network of a plurality of safety controllers 10a-d, four by way of example here, which are connected to one another by means of their respective interface 30 via a bus 32. The safety controllers 10a-d do not have to be made in the same manner among one another, that is they can have a different number of connector modules 16, of inputs 18, of outputs 22 and different connected sensors 20, actuators 24 as well as a different evaluation logic. In practical application, each safety controller 10a-d is associated with a self-contained part of a modular plant, for example with an individual machine, to monitor this part in a technical safety aspect.

The safety controllers 10a-d exchange the relevant control information among one another via the network 32. This is, for example, an emergency stop which is triggered in the machine monitored by the safety controller 10c, but should stop the whole plant. The evaluation logic of every single safety controller 10a-d therefore does not only link the input signals at its own inputs 18 with its logic rules, but also the control-relevant information on control signals in its outputs 22 received via the network 32. The information on the control signals determined in this manner is possibly additionally communicated to the other safety controllers 10a-d via the process image. So that the control program can make a decision autonomously in each safety controller 10a which of the relevant pieces of control information should actually be included in the logic rules, the complete process images are communicated without each safety controller 10a-d having to include all information of the process images in its logic rules. It is alternatively conceivable only to exchange a part of the process images or to exchange other, further compressed information, for example that an emergency stop was triggered.

Each of the safety controllers 10a-d is made for the exchange of the process images as a master, transmits its then current process image to all other safety controllers 10a-d and correspondingly receives the process images of the other safety controllers 10a-d, as shown in the lower part of FIG. 1. In this respect, process images of eight bytes in width, which are summed to 32 bytes of process data with four safety controllers 10a-d, are to be understood purely by way of example. The process images cannot only differ from this in total, but even from safety controller 10a-d to safety controller 10a-d.

The configuration shown in FIG. 1 is a projected maximum total system. The control program of each safety controller 10a-d is first configured so that it receives the process data of the other safety controllers in operation since the logic rules can be defined in dependence on the process data or parts of the process data thus received.

FIG. 2 shows a part configuration of the maximum configuration of FIG. 1. In this respect, two safety controllers 10c-d have been removed from the network, as illustrated by hatching behind a rectangle 34. The actually present network thus only comprises two safety controllers 10a-b. Since the logic rules of the control program, however, expect the information of the missing safety controllers 10c-d, the process data not communicated via the network are replaced by predefined process data (default process image) which are stored in the respective memory 15 of the safety controllers 10a-b. The predefined process data are selected so that the existing safety controllers 10a-b also deliver meaningful control signals in the presence of the safety controllers 10c-d, that is, for example, with process data such as correspond to the undisturbed normal operation of the safety controllers. In the example used multiple times of an emergency stop which would be provided at one of the missing safety controllers 10c-d, the process data representing the emergency stop switch, for instance, are set such that the emergency stop switch is not activated.

In the projecting of the maximum total system in accordance with FIG. 1, the predefined process data are also fixed and made known to the other safety controllers 10a-d for each participant, that is for each safety controller 10a-d.

Due to the predefined process data, the part configuration of FIG. 2 is also completely operable without anything having to be changed at the control programs and without the logic rules having to make case distinctions to detect the possible part configurations.

The safety controllers 10a-d check whether they belong to the same maximum configuration, for example by exchange of a clear cluster identification number. It is thus ensured that the predefined process data match one another. This check primarily takes place on the booting of the plant. If a participant from another cluster is recognized, the system does not start.

The actual part configuration, such as is shown by way of example in FIG. 2, is stored in the safety controllers 10a-d. On the booting of the plant, the existing safety controllers 10a-d are compared with the stored part configuration. If all the safety controllers 10a-d have the same cluster identification number and if the network includes all the expected safety controllers 10a-d, the plant can be released.

If the recognized part configuration differs from the stored part configuration, for instance because a safety controller 10a-d is missing, there are two conceivable causes for this: A defect or a direct conversion of the plant. The system therefore queries via a confirmation mechanism whether the changes are intended and whether the recognized plant corresponds to the desired part configuration. If no confirmation is given, the release is refused. After confirmation has been given, the new part configuration is saved and the safety controllers 10a-d of the cluster work with the predefined process data for the safety controllers 10a-d missing with respect to the maximum configuration. No further steps are necessary to adapt the network of safety controllers 10a-d to the converted plant apart from the disconnection of safety controllers 10a-d to be removed or from the new connections of replaced safety controllers 10a-d and from the authorization of the new part configuration.

1. A safety controller (10) having at least one input (18) for the connection of a sensor (20), at least one output (22) for the connection of an actuator (24), at least one communications interface (30) for the connection of a second safety controller (10a-d) to exchange control-relevant information and having a control unit (14) which is configured to carry out a control program which generates a control signal with reference to presettable logic rules at the outputs (22) in dependence on input signals at the inputs (18) and/or in dependence on the control-relevant information,
characterized in that
the control program, when it determines that an expected safety controller (10a-d) is not connected, uses predefined information instead of the control-relevant information to be transferred from the expected safety controller (10a-d).

2. A safety controller (10) in accordance with claim 1, wherein the control-relevant pieces of information are at least parts of the process image of the respective safety controller (10a-d).

3. A safety controller (10) in accordance with claim 1, wherein the predefined pieces of information are at least parts of a notional process image of the expected safety controller (10a-d) in undisturbed operation.

4. A safety controller (10) in accordance with claim 1, wherein the communications interface (30) is made for a secure communication.

5. A safety controller (10) in accordance with claim 1, which is of modular construction and has at least one connector module (16) with the inputs (18) and/or the outputs (22), wherein a first connector module (16a) is connected to the control unit (14) and the further connector modules (16b-d) are connected to respectively one prepositioned connector module (16a-c) so that the control unit (14) forms a module series with the connector modules (16a-d).

6. A safety controller (10) in accordance with claim 5, wherein the control unit (14) forms a control module (12) and both the connector modules (16a-d) and the control modules (12) are accommodated in one respective housing with an external geometry identical in at least some dimensions; and wherein each connector module (16a-d) has a connection for a prepositioned module (12, 16a-c) and a connection for a postpositioned module (16b-d) of the module series.

7. An arrangement comprising a plurality of safety controllers (10a-d) in a network connected via the communications interfaces (30), each safety controller having at least one input (18) for the connection of a sensor (20), at least one output (22) for the connection of an actuator (24), at least one communications interface (30) for the connection of a second safety controller (10a-d) to exchange control-relevant information and having a control unit (14) which is configured to carry out a control program which generates a control signal with reference to presettable logic rules at the outputs (22) in dependence on input signals at the inputs (18) and/or in dependence on the control-relevant information, wherein the control program, when it determines that an expected safety controller (10a-d) is not connected, uses predefined information instead of the control-relevant information to be transferred from the expected safety controller (10a-d), wherein one of the safety controllers (20a-d) is made as a master and the remaining safety controllers (10a-d) are made as slaves; or wherein a plurality of or all of the connected safety controllers (10-d) are made as masters in a multi-master network.

8. An arrangement in accordance with claim 7, wherein the control program of each safety controller (10a-d) in the network uses logic rules for a preset maximum configuration with a preset maximum number of safety controllers (10a-d).

9. An arrangement in accordance with claim 8, wherein the control programs of the individual safety controllers (10a-d) of the arrangement among one another compare, in particular on activation of the safety controller (10a-d), whether all the safety controllers (10a-d) of the arrangement are made for the same maximum configuration.

10. An arrangement in accordance with claim 8, wherein the control programs of the individual safety controllers (10a-d) of the arrangement among one another compare, in particular on activation of the safety controller (10a-d), whether the safety controllers (10a-d) of the arrangement correspond to a stored part configuration of the maximum configuration.

11. A method for the generation of control signals to at least one actuator (24) at an output (22) of a safety controller (10) with reference to presettable logic rules in dependence on input signals from at least one sensor (20) at an input (18) of the safety controller (10) and in dependence on control-relevant information which is exchanged with a further safety controller (10a-d) at least one communications interface (30),
characterized in that,
when an expected safety controller (10a-d) is not connected to a communications interface (30), predefined information is used for the generation of the control signals instead of the control-relevant information to be transferred from the expected safety controller (10a-d).

12. A method in accordance with claim 11, wherein the logic rules and the predefined information are configured for a maximum configuration of a maximum number of safety controllers (10a-d) in a network.

13. A method in accordance with claim 12, wherein an adaptation to a part configuration of the maximum configuration takes place in that safety controllers (10a-d) are removed from or replaced in the network, with the changed configuration in particular being released by an authorization.

14. A method in accordance with claim 12, wherein a check is made, in particular on activation of the safety controller (10a-d), whether all the safety controllers (10a-d) connected to form a network are made for the same maximum configuration.

15. A method in accordance with claim 12, wherein a check is made, in particular on activation of the safety controller (10a-d), whether all the safety controllers (10a-d) connected to form a network correspond to a stored part configuration of the maximum configuration.
